(19) United States
(12) Patent Application Publication
(10) Pub. No.: US 2021/0364175 A1
(43) Pub. Date: Nov. 25, 2021

(54) Solar Fan Device

(71) Applicant: Kohl Naehu, Kaunakakai, HI (US)

(72) Inventor: Kohl Naehu, Kaunakakai, HI (US)

(21) Appl. No.: 16/880,990

(22) Filed: May 22, 2020

(51) Int. Cl. F24F 5/00; F24F 7/007

(52) U.S. Cl. CPC F24F 5/0046; F05B 2220/708; F24F 2005/0067; F24F 7/007

(57) ABSTRACT

A solar fan device a fan member, a motor member, a solar panel member and an alternate power source member. The fan member having an enclosure formed by an attachment of a front cover member and a rear cover member with one or more removable fasteners securing the closure of the enclosure. The enclosure including a plurality of interchangeable fan blades which are arranged around a spindle member positioned in the enclosure. The spindle member is attached to a motor member which causes the plurality of blades to rotate when the motor member turns on. The motor member actuates the rotation motion of the plurality of interchangeable fan blades. The solar panel member powers the motor member. The alternate power source member provides power to the motor member when the solar panel member is not providing power to the motor member.

### FIELD OF THE INVENTION

Embodiments described herein generally relate to fan devices, and more particularly to solar powered fan devices.

### BACKGROUND OF THE INVENTION

In the modern world, ventilation and temperature management are an essential aspect of comfort. However, providing these amenities is often expensive and if overused, will result in higher costs. The expenses attached to altering temperature and improving ventilation are often a deterrent to using these amenities and as a result persons experience discomfort. Hence, an improved way to implement ventilation and temperature management is desirable.

### BRIEF DESCRIPTION OF THE DRAWINGS

The various advantages of the embodiments of the present disclosure will become apparent to one skilled in the art by reading the following specification and appended claims, and by referencing the following drawing(s), in which:

FIG. 1 shows an exemplary view of a solar fan device according to an embodiment of the present disclosure.

FIG. 2 shows another exemplary view of the solar fan device according to an embodiment of the present disclosure.

### SUMMARY OF THE INVENTION

Exemplary embodiments disclosed herein describe a solar fan device including a fan member, a motor member, a solar panel member and an alternate power source member. The fan member having an enclosure formed by an attachment of a front cover member and a rear cover member with one or more removable fasteners securing the closure of the enclosure. The enclosure including a plurality of interchangeable fan blades which are arranged around a spindle member positioned in the enclosure. The spindle member is attached to a motor member which causes the plurality of blades to rotate when the motor member turns on. The motor member actuates the rotation motion of the plurality of interchangeable fan blades. The solar panel member powers the motor member. The alternate power source member provides power to the motor member when the solar panel member is not providing power to the motor member.

In some exemplary embodiments, the device includes a pedestal stand member for positioning the fan member a predetermined distance above the ground and for stabilizing the device.

In some exemplary embodiments, the diameter size of the plurality of fan blades is adjustable.

In some exemplary embodiments, the device includes a power cord for transferring power from the solar panel member to the motor member.

In some exemplary embodiments, the solar panel member is a one (100) hundred watt photovoltaic panel.

In some exemplary embodiments, the alternate power source is a battery.

### DETAILED DESCRIPTION

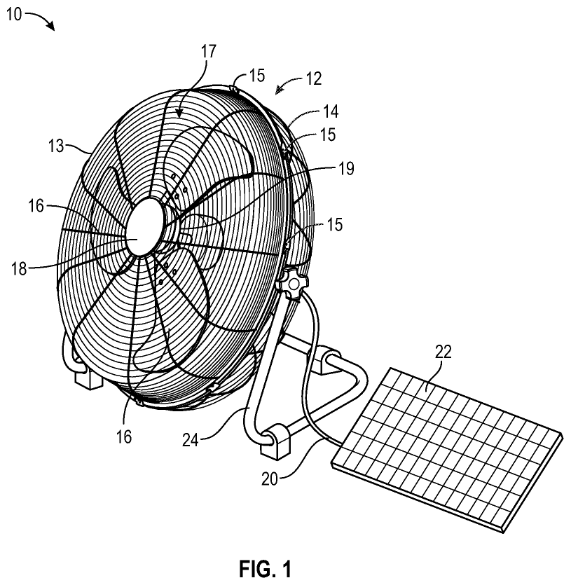

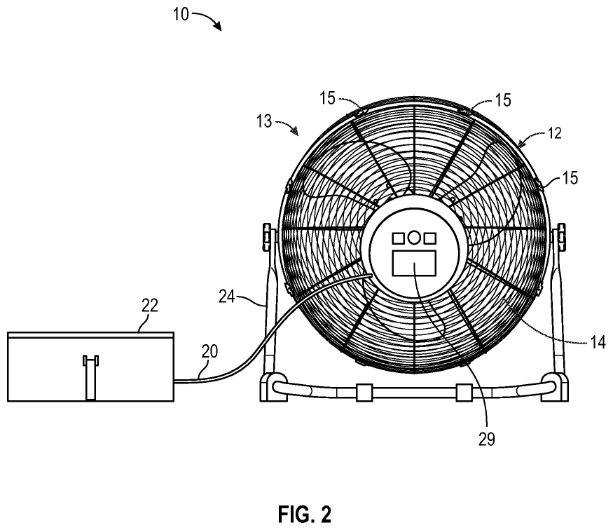

The present disclosure relates to a large solar fan device (“the device”). The device provides affordable ventilation and temperature management. As illustrated in FIGS. 1-2, the device 10 includes a fan member 12, motor member 19, a solar panel member 22 and an alternate power source. The fan member having an enclosure 17 formed by an attachment of a front cover member 13 and a rear cover member 14 with one or more removable fasteners 15 securing the closing of the enclosure 17. The enclosure including a plurality of fan blades 16 which are arranged around a spindle member 18 positioned in the enclosure, the spindle member is attached to a motor member 19 which causes the plurality of blades to rotate when the motor member turns on.

The front cover member 13 and rear cover member may have a circular net-like structure. The front cover member and the rear cover member may be made out of any suitable material, such as, for example, metal. Any suitable fasteners may be used for the removable fasteners.

The plurality of fan blades 16 may have adjustable diameter sizes. The device 10 may be configured to operate with different diameter size blades. In essence, the device may be custom built with blades having a diameter size specified by a user. In another exemplary embodiment, the plurality of blades may be interchangeable. Hence, a set of blades may be removed from the device 10 and a different set of blades may be attached to the device having a different diameter. The plurality of fan blades may be operated at an adjustable speed and the rotation direction may be changed.

The motor member 19 may include an electric fan motor. The motor member actuates the rotation motion of the plurality of fan blades 16. The motor member may be powered by the solar panel member 22. The solar panel member may include a one hundred (100) watt photovoltaic panel. Alternately, the motor member may be powered by an alternate power source. The alternate power source may be a twelve volt (12V) battery 29. The alternate power source powers the motor member when the solar panel member is not powering the motor member, such as, for example, when the sun goes down. The photovoltaic cells in solar panel member 22 must have sunlight to create electricity. Hence, the alternate power source may be used to power the motor member at night. The device includes a power cord 20 for transferring power from the solar panel member 22 to the motor member 19.

The device 10 includes a pedestal stand member 24 for positioning the fan member a predetermined distance above the ground and for stabilizing the device.

Moreover, it should be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A solar fan device comprising:
a fan member having an enclosure formed by an attachment of a front cover member and a rear cover member with one or more removable fasteners securing the closing of the enclosure, the enclosure including a plurality of fan blades which are arranged around a spindle member positioned in the enclosure, the spindle member is attached to a motor member which causes the plurality of blades to rotate when the motor member turns on;
a motor member for actuating the rotation motion of the plurality of fan blades;
a solar panel member for powering the motor member; and
an alternate power source for powering the motor member when the solar panel member is not powering the motor member.

2. The device of claim 1, further comprising a pedestal stand member for positioning the fan member a predetermined distance above the ground and for stabilizing the device.

3. The device of claim 1, wherein the diameter size of the plurality of fan blades is adjustable.

4. The device of claim 1, further comprising a power cord for transferring power from the solar panel to the motor member.

5. The device of claim 1, wherein the solar panel member is a one (100) hundred watt photovoltaic panel.

6. The device of claim 1, wherein the alternate power source is a battery.
